(19) United States
(12) Patent Application Publication
(10) Pub. No.: US 2013/0129936 A1
(43) Pub. Date: May 23, 2013

(54) METHOD AND APPARATUS FOR ENABLING THE CURING OF THE COATING OF A PART BY MEANS OF FREE RADICALS GENERATED BY ULTRAVIOLET RADIATION (UV)

(71) Applicants: Gorka Perez Zabala, Lezo (Gipuzkoa) (ES); Joseba Koldo Pelaez Agirre, Lezo (Gipuzkoa) (ES)

(72) Inventors: Gorka Perez Zabala, Lezo (Gipuzkoa) (ES); Joseba Koldo Pelaez Agirre, Lezo (Gipuzkoa) (ES)

(73) Assignee: Lifitec S.L.U, Lezo(Gipuzkoa) (ES)

(21) Appl. No.: 13/812,786

(22) PCT Filed: Jul. 28, 2011
(86) PCT No.: PCT/ES11/00242

§ 371 Date: Jan. 28, 2013

(30) Foreign Application Priority Data
Jul. 29, 2010 (ES) P201000990

(51) Int. Cl. B05D 3/06; B05C 9/12; G01N 21/00

(52) U.S. Cl. CPC B05C 9/12; B05D 3/067
USPC 427/558; 250/453.11

(57) ABSTRACT

Apparatus for curing the coating of a workpiece (1), which comprises at least one tank (2) with inert gas heavier than air into which the workpiece (1) is inserted, and at least one UV-radiation source (3) that generates radiation that falls on the workpiece (1) to bring about the curing. The apparatus also comprises an extraction area (4), a recirculation circuit (5) and an insertion area (6), where, respectively, inert gas is extracted from the tank (2), recirculated, and reintroduced into the tank (2). At least one inert gas cooling member (7) is situated in the recirculation circuit (5), thus preventing the inert gas inside the tank (2) from overheating and reducing the risk of instability in the inert gas atmosphere.

### TECHNICAL FIELD

The invention relates to a method and apparatus for curing the coating of a workpiece with free radicals generated by means of ultraviolet (UV) radiation.

### PRIOR ART

Curing by ultraviolet (UV) radiation is a widely used technique for drying or curing certain types of liquid coatings, which turns them into solid thy compounds almost immediately. This type of curing is used in various industrial and even domestic applications, e.g. to produce immediate curing of dyes, varnishes, adhesives and paint. This curing technique is based on projecting UV radiation on a workpiece or a substrate provided with a coating or finish; said coating is in the form of a liquid composition that comprises a mixture of oligomers (polymers with a low molecular weight), monomers, additives and pigments, as well as compounds known as photoinitiators, which absorb UV radiation and generate free radicals. When the UV radiation reaches the coating, the photoinitiators cause the aforementioned generation of free radicals, which also cause the cross-linking (formation of a type of three-dimensional network) of the oligomers contained in the composition of the coating, with the subsequent formation a dry final coating layer.

It is known that performing UV-radiation curing in an atmospheric environment containing air is not satisfactory, due to the fact that oxygen in the air inhibits the reactivity of the composition of the coating. There are known proposals to address this problem, such as the one presented in EP1235652, in which curing is carried out by the radiation of sunlight or UV lamps in an environment or atmosphere mainly consisting of a heavy gas (preferably CO₂), with a low oxygen content. As a result, the presence of oxygen and its negative influence on the curing is reduced. A later document US20080003372 is also known, in which a method and apparatus for free-radical LTV-radiation curing is described, with the particularity that the curing is implemented by immersing the substrate provided with the coating in a tank containing an inert gas atmosphere (preferably CO₂). Immersion takes place at a depth where the concentration of oxygen is sufficiently low and constant. Once the substrate is immersed, UV radiation is applied on the substrate to cure its coating. Once the coating is dry, the substrate is extracted from the inert gas atmosphere. UV radiation is applied from UV-radiation sources situated on the exterior of the tank, the UV radiation passing through a window located on the wall of the tank.

A problem common to the various known apparatus, including the one described in US20080003372, is that UV-radiation emitting lamps give off heat in the form of infrared (IR) radiation, which is transmitted to the inert gas atmosphere and causes instability in the system. This problem arises in the case of US20080003372, in which a two-dimensional, horizontally disposed substrate or workpiece is cured, as the gas level must only be kept constant up to a relatively low height (mark 1.4.2), later being disposed with a distance up to a greater height (mark 1.4.1) in order to disperse the turbulence in the gas. However, apparatus designed to cure three-dimensional workpieces or workpieces of a certain height would have to be excessively high in order to function in the same way as the apparatus in US20080003372, i.e. to enable the dispersal of turbulence in the gas situated on top of the workpiece. Evidently, such apparatus are not feasible. As a result, in apparatus for curing three-dimensional workpieces, which cannot be excessively large, the instability in the inert gas atmosphere would result in gas leaking from the apparatus, meaning that more inert gas would have to be injected into the apparatus to maintain stability. Consequently, the apparatus would consume an excessive amount of gas.

A possible solution to the problem of preventing turbulence caused by IR radiation inside a curing apparatus is to place the UV-radiation sources at a certain distance from the apparatus. However, this solution is not deemed useful from a technical standpoint as it may result in the unit formed by the apparatus and the UV-radiation sources being excessively large. In addition, more powerful UV-radiation sources would have to be used in this case, impacting negatively on the consumption of the apparatus.

The objective of the invention is to provide an apparatus for curing coatings that are formed by compositions that may be cured by means of free radicals generated by UV radiation, where the heating of the interior of the tank is reduced as far as is possible, preventing turbulence in the inert gas atmosphere, with, in other words, a stable system being obtained. An additional object is that the apparatus consumes a reduced amount of inert gas.

### BRIEF DESCRIPTION OF THE INVENTION

It is an object of this invention to provide a method and an apparatus for curing the coating of a workpiece, where said coating is formed by a free radical UV-radiation curable composition. As other known apparatus in the prior art, the apparatus comprises at least one tank that contains inert gas heavier than air and into which the workpiece is inserted, and at least one radiation source responsible for generating the radiation that falls on the workpiece to cure its coating. With the aim of reducing the temperature of the inert gas contained in the tank (which heats up as a result of the effect of the radiation) and thereby reduce the turbulence inside the tank, the inventive apparatus comprises an inert gas extraction area, an inert gas recirculation circuit and an inert gas insertion area, by which, respectively, inert gas is extracted from the tank, said inert gas is recirculated and inert gas is inserted into the tank. The recirculation circuit comprises at least one inert gas cooling member; in other words, the inventive apparatus comprises an inert gas recirculation and cooling circuit. The inventive method comprises steps of extracting hot inert gas from the tank, cooling said gas and inserting the temperature-decreased gas again into the tank. This system keeps the temperature of the inert gas inside the tank at acceptable levels.

In principle, the cooling member may be of any applicable type, such as an electrical refrigerator. However, the invention contemplates another interesting embodiment that is described hereafter.

Preferably, the inert gas is CO₂ and the inert gas cooling member comprises a heat exchange chamber in which solid CO₂ is provided. This embodiment is especially advantageous as it allows two functions to be performed at the same time. Firstly, as the solid CO₂ is colder than the recirculating CO₂ extracted from the tank, the solid CO₂ cools the recirculating CO₂. Secondly, the solid CO₂ sublimes as a result of the cooling, combining with the recirculating CO₂ and also being introduced into the tank. In other words, the addition of solid CO₂ cools the tank and supplies the gas tank at the same time. And, in comparison with other cooling members such as electrical refrigerators, the embodiment saves electric power.

### BRIEF DESCRIPTION OF THE DRAWINGS

Details of the invention can be seen in the accompanying non-limiting drawings:

FIG. 1 shows a schematic view of an embodiment of the inventive curing apparatus.

### DETAILED DESCRIPTION OF THE INVENTION

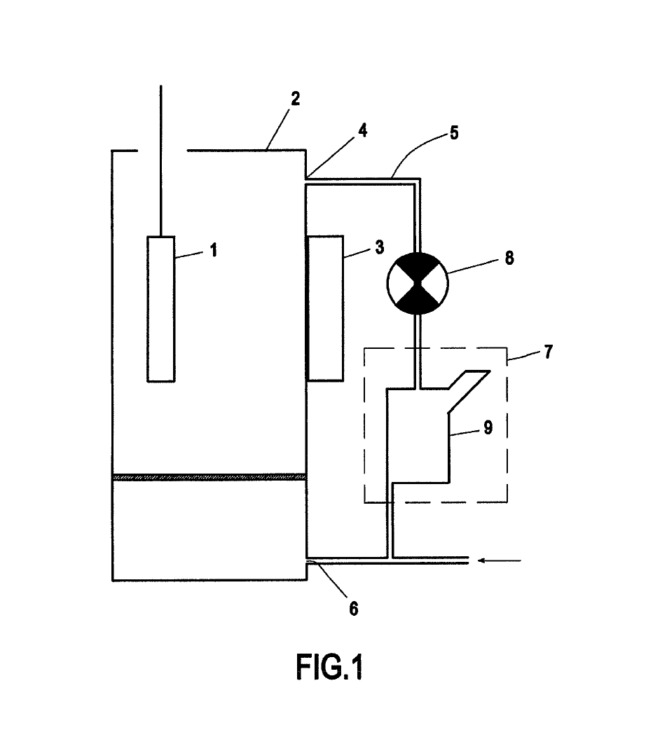

FIG. 1 shows a schematic view of an embodiment of the inventive apparatus for curing the coating of a workpiece (1), where said coating is formed by a composition that may be cured by means of free radicals generated by UV radiation. As can be seen in the FIGURE, the apparatus comprises at least one tank (2), which contains inert gas heavier than air, and into which the workpiece (1) is inserted, and at least one UV-radiation source (3) that generates radiation that hits the workpiece (1) to cure its coating. To prevent an excessive increase in the temperature of the inert gas contained in the tank (2), which would cause turbulence and, therefore, instability in the system, the apparatus also comprises an inert gas extraction area (4) or outlet area through which the inert gas can exit the tank (2) (in this case said extraction is caused by a suction pump (8)); an inert gas recirculation circuit (5); an inert gas insertion area (6) or inlet area through which the recirculating inert gas may return to the tank (2). The recirculation circuit (5) comprises at least one cooling member (7) that allows the recirculating inert gas to be cooled so that the inert gas that enters the tank (2) through the insertion area (6) has a lower temperature than the inert gas that exits through the extraction area (4).

Preferably, the extraction area is located above the UV-radiation source (3). The temperature of the inert gas is higher in this area in the tank (2). As a result, the extraction of the inert gas from said area guarantees more efficient cooling.

The cooling member (7) may be any member that enables the circulating inert gas to be cooled. In one embodiment, the cooling member (7) comprises an electrical refrigerator. In another embodiment, in which the inert gas is CO₂, the inert gas cooling member (7) comprises a heat exchange chamber (9) in which solid CO₂ is supplied. This aspect, as mentioned earlier, is especially advantageous as it allows two functions to be performed through the supply of a single element (solid CO₂): the cooling of the recirculating CO₂, and the supply of additional CO₂ to the apparatus in order to keep it supplied in the event of possible losses. This second embodiment is also less power-consuming than the first.

The inventive method comprises the following steps: extracting inert gas through an extraction area (4) of the tank (2); recirculating the extracted inert gas through a recirculation circuit (5), including the step of cooling the inert gas in a cooling member (7) comprised in said recirculation circuit (5); entering the cooled inert gas into the tank (2) through an insertion area (6).

Preferably, the inert gas is CO₂ and the method comprises the additional step wherein the cooling member (7) is supplied with solid CO₂.

In the embodiment shown, the UV-radiation source (3) is located in the outer part of the tank (2). However, this aspect is not relevant to this invention; in different embodiments, the UV-radiation source (3) may be situated in other areas of the apparatus.

1. Apparatus for curing the coating of a workpiece (1), where said coating is made of a composition that may be cured by means of free radicals generated by ultraviolet (UV) radiation, where the apparatus comprises at least one tank (2)that contains inert gas heavier than air and into which the workpiece (1) is inserted, and at least one UV-radiation source (3) that generates radiation that falls on the workpiece (1) to cure its coating, characterised in that it comprises:
an inert gas extraction area (4), an inert gas recirculation circuit (5) and an inert gas insertion area (6), where, respectively, inert gas is extracted from the tank (2), said inert gas is recirculated and inert gas is introduced into the apparatus towards the tank (2), where
the recirculation circuit (5) comprises at least one inert gas cooling member (7).

2. Apparatus according to claim 1, characterised in that the extraction area is situated above the LTV-radiation source (3).

3. Apparatus according to claim 1, characterised in that the cooling member (7) comprises an electrical refrigerator.

4. Apparatus according to claim 1, characterised in that the inert gas is CO₂ and in that the inert gas cooling member (7) comprises a heat exchange chamber (9) in which solid CO₂ is supplied.

5. Method for the curing of the coating of a workpiece (1), where said coating is made of a composition that may be cured by means of free radicals generated by ultraviolet (UV) radiation, where said workpiece (1) is introduced into a tank (2) of a curing apparatus, the tank (2) containing inert gas heavier than air, and the apparatus comprising at least one UV-radiation source (3) that generates radiation that falls on the workpiece (1) for the curing of its coating, where said method is characterised in that it comprises the following steps:
extracting inert gas through an extraction area (4) of the tank (2),
recirculating the extracted inert gas through a recirculation circuit (5), including the step of cooling the inert gas in a cooling member (7) comprised in said recirculation circuit (5),
inserting the cooled inert gas into the tank (2) through an insertion area (6).

6. Method according to claim 5, characterised in that the inert gas is CO₂, and the method comprises the additional step of supplying solid CO₂ to the cooling member (7).
